(19) United States
(12) Patent Application Publication
(10) Pub. No.: US 2026/0357070 A1
(43) Pub. Date: Nov. 12, 2026

(54) COLORED GRANULES HAVING IMPROVED COLORANT STABILITY

(71) Applicant: Novozymes A/S, Bagsvaerd (DK)

(72) Inventor: Ole Simonsen, Soeborg (DK)

(73) Assignee: Novozymes A/S, Bagsvaerd (DK)

(21) Appl. No.: 19/129,251

(22) PCT Filed: Nov. 22, 2023
(86) PCT No.: PCT/EP2023/082719

§ 371 Date: May 12, 2025

(30) Foreign Application Priority Data
Nov. 22, 2022 (EP) 22208900.5

(51) Int. Cl. C09B 67/08; C09B 61/00; C09B 67/38; C11D 1/00; C11D 1/72; C11D 3/08; C11D 3/10; C11D 3/12; C11D 3/20; C11D 3/39; C11D 3/40; C11D 17/06

(52) U.S. Cl. CPC C09B 67/0007; C09B 61/00; C09B 67/008; C11D 1/008; C11D 1/72; C11D 3/08; C11D 3/10; C11D 3/122; C11D 3/2086; C11D 3/391; C11D 3/40; C11D 17/06; C11D 2111/14

(57) ABSTRACT

The invention provides colored granules having improved color stability. The colored granules comprise (a) a colored core comprising a colorant and (b) a salt coating surrounding the core making up 1-50% w/w of the granule and comprising at least 60% w/w of a salt having constant relative humidity at 20 °C of at least 60% (sodium sulfate), which forms a continuous layer having few or no holes. Solid detergent composition comprising a surfactant, a builder, and the colored granule, preferably further comprising a bleaching system component.

### FIELD OF THE INVENTION

The present invention relates to colored granules exhibiting improved colorant stability.

### BACKGROUND

Small granules are often used as a delivery vehicle for a compound of interest, or simply as a small colored particle, in aqueous applications. Such granules may be whitened or colored to mask a greyish appearance to improve customer appeal.

Colorants used to provide a colorful appearance of such granules must be sufficiently stable to withstand fading in many different environments, where the granules are stored before being used in an application. The present invention describes how to protect such colorants, while maintaining the colorful appearance.

### SUMMARY OF THE INVENTION

The present invention provides, in a first aspect, a colored granule, comprising
(a) a colored core comprising a colorant, and
(b) a salt coating surrounding the core, which makes up 1-50% w/w of the granule, and comprises at least 60% w/w of a salt having a constant relative humidity at 20 °C of at least 60%.

In an embodiment, the colored granule comprises a compound of interest.

In another aspect, the invention provides a solid detergent composition comprising a surfactant and a builder, and the colored granule(s) of the invention.

Other aspects and embodiments of the invention are apparent from the description and examples.

Unless otherwise indicated, or if it is apparent from the context that something else is meant, all percentages are percentage by weight (% w/w).

As used herein, the term “consists essentially of” (and grammatical variants thereof), as applied to the compositions and methods of the invention, means that the compositions/methods may contain additional components so long as the additional components do not materially alter the composition/method.

As used herein, the term “essentially free of” (and grammatical variants thereof), as applied to the compositions and methods of the invention, means that the compositions/methods may contain minor amounts of the specified component so long as the amount of the component does not materially alter, or provide any material effect on, the composition/method. In an embodiment, “essentially free of” means 0% w/w.

### DETAILED DESCRIPTION

We have found that a simple salt coating can prevent degradation/fading of colorants in colored granules, while not significantly reducing the color intensity. This has not previously been recognized. Traditionally, granules have been colored by applying a colorant coating layer on the outside of a salt coating. However, contrary to expectations, we found that salt coatings are highly transparent and do not significantly reduce the color of the colorant coating. This has the strong advantage that the colorant is protected from fading due to degradation by chemical oxidation and oxidative photodegradation. This is of particular importance when labile plant derived colors are used as a natural and sustainable coloring option.

### Colored Granules

A colored granule of the invention is a small particle comprising a core which is colored and comprises a colorant, and a salt coating surrounding the core which makes up 1-50% w/w of the total granule and comprises at least 60% w/w of a salt having a constant relative humidity at 20 °C of at least 60%. Preferably, the colored granule is water soluble/dispersible.

The granule may comprise a compound of interest and be used as a delivery vehicle for releasing the compound of interest into an aqueous environment when used in an application. Thus, the granule may be used to temporarily protect such compounds, but they may also simply be used as a convenient way of distributing a compound of interest which would otherwise be a dusty powder.

The granule may comprise the compound of interest in an amount of 0.05-50% w/w, such as 0.1-30% w/w, 0.5-25% w/w, or 1-20% w/w.

In an embodiment, the granule comprises less than 10% w/w surfactant; preferably less than 5% w/w, or less than 2% w/w surfactant.

The compound of interest may be a functional or reactive ingredient, for example a protein, such as an enzyme (as described below), or a bleach catalyst (e.g. manganese bleach catalysts like MnTACN) and/or bleach activator (e.g. TAED, NOBS), or other compounds, like percarbonates, that need to be separated from the surrounding environment during storage.

Typically, the particle size, measured as equivalent spherical diameter (volume based average particle size), of the granule is 20-2000 μm, particularly 50-1500 μm, 100-1500 μm or 250-1200 μm. Preferably, the granule is (roughly) spherical.

The color of the colored granules may be described by the Hunter L,a,b coordinates. The sum of the numerical “a” and “b” values (|a|+|b|) within the Hunter L,a,b color space may be at least 20; preferably at least 30, at least 40, or at least 50. Alternatively, the square root of the sum of squares of the “a” and “b” values (\sqrt{a²+b²}) may be at least 20; preferably at least 30, at least 40, or at least 50.

### Core

The colored core comprises a colorant, as described below, and may include additional materials, such as fillers, fibre materials (cellulose or synthetic fibres), stabilizing agents, solubilizing agents, suspension agents, viscosity regulating agents, light spheres, plasticizers, salts, lubricants, fragrances, and binders, such as synthetic polymer, wax, fat, or carbohydrate. The ingredients of the core may be mixed as a homogenous blend.

The core may consist of an inert particle, or an inert particle with a compound of interest applied (coated) onto the surface of the inert particle, e.g., via seeded mixer granulation or layered granulation in a fluid bed. Such inert particles can be an organic particulate compound e.g. a natural compound such as agglomerated carbohydrates, e.g. sugars, starch, dextrins, flour (e.g. vegetable flour), or nonpareils. Nonpareils are spherical particles made of a seed crystal that has been built onto and rounded into a spherical shape. Nonpareils are typically made from a combination of a sugar such as sucrose, and a powder such as cornstarch. The inert particle can also be a sodium chloride or sodium sulfate crystal (or agglomerated crystals), also referred to as a seed, or other inorganic salt crystal; or a sucrose crystal.

The core can also be prepared by granulating a blend of the ingredients, with or without a compound of interest, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation.

The colorant may be mixed with the other ingredients of the core, as long as the resulting core is colored. The colorant may be applied onto the unfinished core as a coating, preferably so that the colorant is deposited at the surface of the core.

The core may further comprise a coating below the colorant layer that separates the colorant from any reactive compounds, such as a possible compound of interest, in the core. Such a coating could be a salt coating, which will then be a part of the core.

Methods for preparing the core can be found in Handbook of Powder Technology; Particle size enlargement by C. E. Capes; Volume 1; 1980; Elsevier.

### Salt Coating

The colored core is surrounded by a salt coating (an outer layer). The salt coating comprises at least 60% w/w of a salt, e.g., at least 65%, at least 70%, at least 75%, at least 80%, at least 85%, at least 90%, at least 95%, or at least 99% w/w of a salt.

The salt coating may be applied in an amount of at least 1% w/w of the granule, e.g., at least 5%, 10% or 15% w/w. The amount may be at most 70%, 50%, 40% or 30% w/w.

The coating is preferably at least 0.1 μm thick, particularly at least 0.5 μm, at least 1 μm or at least 5 μm. In a particular embodiment the thickness of the coating is below 100 μm. In a more particular embodiment, the thickness of the coating is below 60 μm. In an even more particular embodiment, the total thickness of the coating is below 40 μm.

The coating should surround/encapsulate the core by forming a substantially continuous layer. A substantially continuous layer is to be understood as a coating having few or no holes (substantially impermeable or non-porous), so that the core unit is surrounded/encapsulated with few or no uncoated areas. The layer or coating should in particular be homogeneous in thickness.

The salt may be added from a salt solution where the salt is completely dissolved or from a salt suspension wherein the fine particles is less than 50 μm, such as less than 10 μm or less than 5 μm.

The salt coating may comprise a single salt or a mixture of two or more salts. The salt may be water soluble, in particular having a solubility at least 0.1 grams in 100 g of water at 20 °C, preferably at least 0.5 g per 100 g water, e.g., at least 1 g per 100 g water, e.g., at least 5 g per 100 g water.

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salts are alkali or earth alkali metal ions, the ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used.

The salt in the coating may have a constant relative humidity at 20 °C (also referred to as ‘humidity fixed point’) above 60%, particularly above 70%, above 80% or above 85%, or it may be another hydrate form of such a salt (e.g., anhydrate). The salt coating may be as described in WO 00/01793 or WO 2006/034710.

Specific examples of suitable salts are NaCl (CH_{20 °C}=76%), Na₂CO₃ (CH_{20 °C}=92%), NaNO₃ (CH_{20 °C}=73%), Na₂HPO₄ (CH_{20 °C}=95%), Na₃PO₄ (CH_{25 °C}=92%), NH₄Cl (CH_{20 °C}=79.5%), (NH₄)₂HPO₄ (CH_{20 °C}=93.0%), NH₄H₂PO₄ (CH_{20 °C}=93.1%), (NH₄)₂SO₄ (CH_{20 °C}=81.1%), KCl (CH_{20 °C}=85%), K₂HPO₄ (CH_{20 °C}=92%), KH₂PO₄ (CH_{20 °C}=96.5%), KNO₃ (CH_{20 °C}=93.5%), Na₂SO₄ (CH_{20 °C}=93%), K₂SO₄ (CH_{20 °C}=98%), KHSO₄ (CH_{20 °C}=86%), MgSO₄ (CH_{20 °C}=90%), ZnSO₄ (CH_{20 °C}=90%) and sodium citrate (CH_{25 °C}=86%). Other examples include NaH₂PO₄, (NH₄) H₂PO₄, CuSO₄, Mg(NO₃)₂ and magnesium acetate.

The salt may be in anhydrous form, or it may be a hydrated salt, i.e. a crystalline salt hydrate with bound water(s) of crystallization, such as described in WO 99/32595. Specific examples include anhydrous sodium sulfate (Na₂SO₄), anhydrous magnesium sulfate (MgSO₄), magnesium sulfate heptahydrate (MgSO₄·7H₂O), zinc sulfate heptahydrate (ZnSO₄·7H₂O), sodium phosphate dibasic heptahydrate (Na₂HPO₄·7H₂O), magnesium nitrate hexahydrate (Mg(NO₃)₂(6H₂O)), sodium citrate dihydrate and magnesium acetate tetrahydrate. Preferably the salt is applied as a solution of the salt, e.g., using a fluid bed.

The salt coating may be supplemented with further coating(s) (surrounding the salt coating) that comprises, for example, polyethylene glycol (PEG), methyl hydroxy-propyl cellulose (MHPC), or polyvinyl alcohol (PVA). Such further coating(s) may be added to reduce dusting. In an embodiment, any coating(s) surrounding the salt coating must not significantly reduce the transparency of the combined coatings surrounding the colored core.

### Colorants

The colorants used to color the cores and the granules of the invention include dyes and pigments, which are natural or synthetic substances. The colorants may be naturally occurring colorants, such as plant derived colorants.

Generally, dyes are soluble in water (or organic solvent) while pigments are insoluble, usually as very fine particles. In the context of the invention, white, nuances of grey, and black are not considered colors. Otherwise, colorants in the context of the invention are colored compounds within the common understanding of colors. In an embodiment, the colorants may be described by their Hunter L,a,b coordinates. The sum of the numerical “a” and “b” values (|a|+|b|) within the Hunter L,a,b color space may be least 20; preferably at least 30, at least 40, or at least 50. Alternatively, the square root of the sum of squares of the “a” and “b” values (\sqrt{a²+b²}) may be at least 20; preferably at least 30, at least 40, or at least 50.

In an embodiment, the colorants used to color the cores and the granules of the invention are listed in the Colour Index™ (published by the Society of Dyers and Colourists and American Association of Textile Chemists and Colorists) with a Generic Name and a C.I. number. According to the invention, the Colour Index™ is preferably the applicable version existing on Nov. 22, 2022.

The Colour Index Generic Name describes a commercial product by its recognized usage class, its hue, and a serial number.

The colorant may belong to a usage class selected from the group consisting of Acid, Basic, Direct, Food, Mordant, Natural, Reactive, Solvent, Vat, Sulphur, Disperse, and Pigment. Preferred usage classes are Acid, Basic, Direct, Food, Mordant, Natural, Reactive, and Pigment; and in particular, the usage classes are Acid, Basic, Food, and Natural. The usage class generally refers to groups of colorants having similar chemical structures, and this is not as such a property limited to the Colour Index™.

The preferred hue (color) is selected from the group consisting of yellow, orange, red, green, blue, and violet. The hue property is not limited to the Colour Index™, as it reflects the common understanding of color hues. Thus, the colorants used in the invention may have hues that are nuances of yellow, orange, red, green, blue, or violet.

### Compound of Interest

The above-mentioned compound of interest may be a protein, and in particular a protein produced by fermentation. Proteins can cause allergic reactions to humans, and it is generally desirable to encapsulate such compounds in granules to avoid release of protein dust.

Proteins are small (peptides; <50 amino acids) and large (polypeptides; >50 amino acids) biomolecules that perform a vast array of functions within living organisms, including catalyzing reactions, DNA replication, responding to stimuli, providing structure to cells and organisms, and transporting molecules from one location to another. Proteins are composed of chains of polymerized amino acids, which are folded in a very specific three-dimensional structure. The three-dimensional structure is critical for maintaining the function of the protein. Some chemicals can change the folding, or even unfold (denaturing) the three-dimensional structure, which will result in loss of function, such as loss of enzymatic activity.

In an embodiment, the proteins are polypeptides.

Proteins fall into at least three distinct groups, namely enzymes, cell signaling and ligand binding proteins, and structural proteins.

Enzymes are described below. Cell signaling and ligand binding proteins include many pharmaceutical proteins such as, for example, receptors, membrane proteins, ion channels, antibodies (e.g. single-domain antibodies) and hormones; while structural proteins provide stiffness and rigidity to otherwise-fluid biological components.

Preferably, the proteins are enzymes or cell signaling and ligand binding proteins; more preferably the proteins are enzymes.

The compound of interest may also be other biological molecules or microrganisms. Preferred microroganisms are dehydrated or sporular microorganisms, such as Bacillus endospores.

### Enzymes

The enzymes used as a compound of interest are catalytic proteins, and the term “active enzyme protein” is defined herein as the amount of catalytic protein(s), which exhibits enzymatic activity. This can be determined using an activity based analytical enzyme assay. In such assays, the enzyme typically catalyzes a reaction generating a colored compound. The amount of the colored compound can be measured and correlated to the concentration of the active enzyme protein. This technique is well-known in the art.

The enzyme(s) may be selected from the group consisting of protease, lipase, cutinase, amylase, carbohydrase, cellulase, pectinase, mannanase, arabinase, galactanase, xylanase, nuclease (DNase, RNase), dispersin, catalase, perhydrolase, and oxidase (such as laccase and/or peroxidase). Preferably, the enzyme(s) is a detergent enzyme selected from the group consisting of protease, lipase, amylase, cellulase, pectinase, mannanase, xylanase, nuclease (DNase, RNase), dispersin, catalase, perhydrolase, and combinations thereof.

The protease may be a serine protease, for example a subtilisin. The amylase may be an alpha-amylase or a glucoamylase. The cellulase may be an endo-1,4-beta-glucanase, also referred to as endoglucanase.

The enzyme may be a naturally occurring enzyme of bacterial or fungal origin, or it may be a variant derived from one or more naturally occurring enzymes by gene shuffling and/or by substituting, deleting or inserting one or more amino acids. Chemically modified or protein engineered mutants are included.

The colored granules of the invention may comprise at least one enzyme in an amount of 0.1-25% w/w active enzyme protein; preferably in an amount of 0.5-25% w/w active enzyme protein; and more preferably in an amount of 0.5-20% w/w active enzyme protein.

### Solid Detergent Compositions

The invention also provides solid detergent compositions comprising the colored granules of the invention in combination with one or more additional cleaning composition (detergent) components, as described below. The choice of additional components is within the skill of the artisan and includes conventional ingredients, including the exemplary non-limiting components set forth below. Such detergent compositions may be essentially free of titanium dioxide.

The detergent composition may comprise the colored granules of the invention in an amount up to 10% w/w, preferably in an amount up to 5% w/w.

The choice of additional detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

In one embodiment, the invention is directed to an ADW (Automatic Dish Wash) compositions comprising one or more additional ADW composition components. The choice of additional components is within the skill of the artisan and includes conventional ingredients, including the exemplary non-limiting components set forth below.

The solid detergent composition may be composed essentially of biodegradable materials (be essentially biobased). In a preferred embodiment, the solid detergent composition is >95% biobased according to USDA Certified Biobased Products (biobased content measured using ASTM D6866); more preferably >97% biobased, and most preferably >99% biobased.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant than at least one non-ionic surfactant, the weight ratio of anionic to nonionic surfactant may be from 10:1 to 1:10. In one embodiment the amount of anionic surfactant is higher than the amount of non-ionic surfactant e.g. the weight ratio of anionic to non-ionic surfactant may be from 10:1 to 1.1:1 or from 5:1 to 1.5:1. The amount of anionic to non-ionic surfactant may also be equal and the weight ratios 1:1. In one embodiment the amount of non-ionic surfactant is higher than the amount of anionic surfactant and the weight ratio may be 1:10 to 1:1.1. Preferably the weight ratio of anionic to non-ionic surfactant is from 10:1 to 1:10, such as from 5:1 to 1:5, or from 5:1 to 1:1.2. Preferably, the weight fraction of non-ionic surfactant to anionic surfactant is from 0 to 0.5 or 0 to 0.2 thus non-ionic surfactant can be present or absent if the weight fraction is 0, but if non-ionic surfactant is present, then the weight fraction of the nonionic surfactant is preferably at most 50% or at most 20% of the total weight of anionic surfactant and non-ionic surfactant. Light duty detergent usually comprises more nonionic than anionic surfactant and there the fraction of non-ionic surfactant to anionic surfactant is preferably from 0.5 to 0.9. The total weight of surfactant(s) is typically present at a level of from about 0.1% to about 60% by weight, such as about 1% to about 40%, or about 3% to about 20%, or about 3% to about 10%. The surfactant(s) is chosen based on the desired cleaning application, and may include any conventional surfactant(s) known in the art. When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); in particular, linear alkylbenzenesulfonates (LAS), isomers of LAS such as branched alkylbenzenesulfonates (BABS) and phenylalkanesulfonates; olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate; alcohol ethersulfates (AES or AEOS or FES, also known as alcohol ethoxysulfates or fatty alcohol ether sulfates); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Furthermore, salts of fatty acids (soaps) may be included.

When included therein the detergent will usually contain from about 1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01 to about 10% by weight of a semipolar surfactant. Non-limiting examples of semipolar surfactants include amine oxides (AO) such as alkyldimethylamine oxides, in particular N-(coco alkyl)-N, N-dimethylamine oxide and N-(tallow-alkyl)-N,N-bis(2-hydroxyethyl)amine oxide, and combinations thereof.

When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

Additional bio-based surfactants may be used e.g, wherein the surfactant is a sugar-based non-ionic surfactant which may be a hexyl-β-D-maltopyranoside, thiomaltopyranoside or a cyclic-maltopyranoside, such as described in EP2516606 B1.

### Builders and Co-Builders

The detergent composition may contain about 0-65% by weight, such as about 5% to about 50% of a detergent builder or co-builder, or a mixture thereof. In a dish wash detergent, the level of builder is typically in the range 40-65%, particularly in the range 50-65%. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof. Preferably, the builder(s) are phosphate-free.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N, N-diacetic acid (GLDA), 1-hydroxyethane-1,1-diylbis(phosphonic acid (HEDP), ethylenediaminetetramethylenetetrakis(phosphonic acid) (EDTMPA), diethylenetriaminepentamethylenepentakis (phosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), serine-N,N-diacetic acid (SEDA), isoserine-N,N-diacetic acid (ISDA), phenylalanine-N, N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N, N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854, U.S. Pat. No. 5,977,053.

The solid detergent composition of the invention may comprise a strong sequestering builder; such as at least 0.1% w/w, at least 0.5% w/w, or at least 1% w/w of a strong sequestering builder. Examples of strong sequestering builders are EDTA, EDTMP, NTMP, DTPMP, MGDA, NTA, HEDP, STPP, IDS, and GLDA.

Sequestering builders are different from precipitating builders in that no significant amount of precipitate is formed when the builder is used in an amount sufficient to combine with all of the calcium ions in an aqueous solution with 7°dH water hardness (German hardness) initially at neutral pH. Strong builders are classified as high efficiency chelators that can bind the divalent cations such as Ca²⁺ strongly with a logarithmic stability constant (Log K_{Ca}) of the cation/chelator complex of above 5, particularly above 6 or above 7. The stability constants are determined at an ionic strength of 0.1 M and at a temperature of 25 °C.

### Bleaching Systems

The cleaning composition may contain 0-50% by weight, such as 1-40%, such as 1-30%, such as about 1% to about 20%, of a bleaching system. Any oxygen-based bleaching system comprising components known in the art for use in cleaning detergents may be utilized. Suitable bleaching system components include sources of hydrogen peroxide; peracids and sources of peracids (bleach activators); and bleach catalysts or boosters.

Suitable sources of hydrogen peroxide are inorganic persalts, including alkali metal salts such as sodium percarbonate and sodium perborates (usually mono- or tetrahydrate), and hydrogen peroxide-urea.

Peracids may be (a) incorporated directly as preformed peracids or (b) formed in situ in the wash liquor from hydrogen peroxide and a bleach activator (perhydrolysis) or (c) formed in situ in the wash liquor from hydrogen peroxide and a perhydrolase and a suitable substrate for the latter, e.g., an ester.

Suitable preformed peracids include, but are not limited to, peroxycarboxylic acids such as peroxybenzoic acid and its ring-substituted derivatives, peroxy-α-naphthoic acid, peroxyphthalic acid, peroxylauric acid, peroxystearic acid, ε-phthalimidoperoxycaproic acid [phthalimidoperoxyhexanoic acid (PAP)], and o-carboxybenzamidoperoxycaproic acid; aliphatic and aromatic diperoxydicarboxylic acids such as diperoxydodecanedioic acid, diperoxyazelaic acid, diperoxysebacic acid, diperoxybrassylic acid, 2-decyldiperoxybutanedioic acid, and diperoxyphthalic, -isophthalic and -terephthalic acids; perimidic acids; peroxymonosulfuric acid; peroxydisulfuric acid; peroxyphosphoric acid; peroxysilicic acid; and mixtures of said compounds. It is understood that the peracids mentioned may in some cases be best added as suitable salts, such as alkali metal salts (e.g., Oxone®) or alkaline earth-metal salts.

Suitable bleach activators include those belonging to the class of esters, amides, imides, nitriles or anhydrides and, where applicable, salts thereof. Suitable examples are tetraacetylethylenediamine (TAED), sodium 4-[(3,5,5-trimethylhexanoyl)oxy]benzene-1-sulfonate (ISONOBS), sodium 4-(dodecanoyloxy)benzene-1-sulfonate (LOBS), sodium 4-(decanoyloxy)benzene-1-sulfonate, 4-(decanoyloxy)benzoic acid (DOBA), sodium 4-(nonanoyloxy)benzene-1-sulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that they are environmentally friendly. Furthermore, acetyl triethyl citrate and triacetin have good hydrolytical stability in the product upon storage and are efficient bleach activators. Finally, ATC is multifunctional, as the citrate released in the perhydrolysis reaction may function as a builder.

### Bleach Catalysts and Boosters

The bleaching system may also include a bleach catalyst or booster. Some non-limiting examples of bleach catalysts that may be used in the compositions of the present invention include manganese oxalate, manganese acetate, manganese-collagen, cobalt-amine catalysts and manganese triazacyclononane (MnTACN) catalysts; particularly preferred are complexes of manganese with 1,4,7-trimethyl-1,4,7-triazacyclononane (Me3-TACN) or 1,2,4,7-tetramethyl-1,4,7-triazacyclononane (Me4-TACN), in particular Me3-TACN, such as the dinuclear manganese complex [(Me3-TACN)Mn(O)3Mn (Me3-TACN)](PF6)2, and [2,2′,2″-nitrilotris(ethane-1,2-diylazanylylidene-κN-methanylylidene)triphenolato-κ3O]manganese(III). The bleach catalysts may also be other metal compounds; such as iron or cobalt complexes.

In some embodiments, where a source of a peracid is included, an organic bleach catalyst or bleach booster may be used having one of the following formulae:

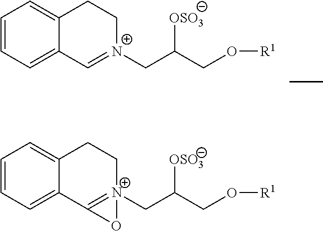

(iii) and mixtures thereof;
wherein R1 is independently a branched alkyl group containing from 9 to 24 carbons or linear alkyl group containing from 11 to 24 carbons, preferably R1 is independently a branched alkyl group containing from 9 to 18 carbons or linear alkyl group containing from 11 to 18 carbons, more preferably R1 is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl.

Other exemplary bleaching systems are described, e.g. in WO 2007/087258, WO 2007/087244, WO 2007/087259, EP 1 867 708 (Vitamin K) and WO 2007/087242.

### Polymers

The detergent may contain 0.005-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl) cellulose (CMC), poly(vinyl alcohol) (PVA), poly(ethyleneglycol) or poly(ethylene oxide) (PEG or PEO), ethoxylated poly(ethyleneimine), (carboxymethyl)inulin (CMI), carboxylate polymers and polycarboxylates such as polyacrylates, maleic/acrylic acid copolymers, acrylate/styrene copolymers, poly(aspartic) acid, and lauryl methacrylate/acrylic acid copolymers, hydrophobically modified CMC (HM-CMC), silicones, copolymers of terephthalic acid and oligomeric glycols, copolymers of poly(ethylene terephthalate) and poly(oxyethene terephthalate) (PET-POET), poly(vinylpyrrolidone) (PVP), poly(vinylimidazole) (PVI), poly(vinylpyridine-N-oxide) (PVPO or PVPNO) and copoly(vinylimidazole/vinylpyrrolidone) (PVPVI). Suitable examples include PVP-K₁₅, PVP-K₃₀, ChromaBond S-400, ChromaBond S-403E and Chromabond S-100 from Ashland Aqualon, and Sokalan® HP 165, Sokalan® HP 50 (Dispersing agent), Sokalan® HP 53 (Dispersing agent), Sokalan® HP 59 (Dispersing agent), Sokalan® HP 56 (dye transfer inhibitor), Sokalan® HP 66 K (dye transfer inhibitor) from BASF. Further exemplary polymers include sulfonated polycarboxylates, polyethylene oxide and polypropylene oxide (PEO-PPO) and diquaternium ethoxy sulfate. Particularly preferred polymer is ethoxylated homopolymer Sokalan® HP 20 from BASF, which helps to prevent redeposition of soil in the wash liqor. Further exemplary polymers include sulfonated polycarboxylates, ethylene oxide-propylene oxide copolymers (PEO-PPO), copolymers of PEG with and vinyl acetate, and diquaternium ethoxy sulfate or quaternized sulfated ethoxylated hexamethylenediamine. Other exemplary polymers are disclosed in, e.g., WO 2006/130575. Salts of the above-mentioned polymers are also contemplated.

### Adjunct Materials

Any detergent components known in the art for use in laundry/ADW/hard surface cleaning detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry/ADW/hard surface cleaning detergents may be utilized. The choice of such ingredients is well within the skill of the artisan.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl) stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Other types of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore, random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines.

The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, and sod suppressors.

Further embodiments of the invention include:

Embodiment 1. A colored granule, comprising
(a) a colored core comprising a colorant, and
(b) a salt coating surrounding the core, which makes up 1-70% w/w of the granule, and comprises at least 60% w/w of salt having a constant relative humidity at 20 °C of at least 60%.

Embodiment 2. The granule of embodiment 1, which further comprises a compound of interest.

Embodiment 3. The granule of embodiment 1, wherein the colored core further comprises a compound of interest.

Embodiment 4. The granule of embodiment 2 or 3, wherein the compound of interest is present in an amount of 0.05-50% w/w of the granule.

Embodiment 5. The granule of embodiment 2 or 3, wherein the compound of interest is present in an amount of 0.1-30% w/w of the granule.

Embodiment 6. The granule of embodiment 2 or 3, wherein the compound of interest is present in an amount of 0.5-25% w/w of the granule.

Embodiment 7. The granule of embodiment 2 or 3, wherein the compound of interest is present in an amount of 1-20% w/w of the granule.

Embodiment 8. The granule of any of embodiments 2-7, wherein the compound of interest is a bleaching system component, such as a bleach activator, a bleach catalyst, or a percarbonate.

Embodiment 9. The granule of any of embodiments 2-7, wherein the compound of interest is a protein.

Embodiment 10. The granule of any of embodiments 2-7, wherein the compound of interest is an enzyme, and the amount is active enzyme protein.

Embodiment 11. The granule of the preceding embodiment, wherein the enzyme is selected from the group consisting of protease, lipase, amylase, cellulase, pectinase, mannanase, xylanase, nuclease, dispersin, catalase, perhydrolase, and combinations thereof.

Embodiment 12. The granule of any of the preceding embodiments, wherein the colored core comprises at least two coatings/layers.

Embodiment 13. The granule of any of the preceding embodiments, wherein the colored core comprises the colorant as a coating.

Embodiment 14. The granule of the preceding embodiment, wherein the colored core comprises a salt coating surrounded by a colorant coating.

Embodiment 15. The granule of any of the preceding embodiments, wherein the colorant is listed in the Color Index.

Embodiment 16. The granule of any of the preceding embodiments, wherein the Color Index hue of the colorant is selected from the group consisting of yellow, orange, red, green, blue, and violet.

Embodiment 17. The granule of any of the preceding embodiments, wherein the Color Index hue of the colorant is yellow.

Embodiment 18. The granule of any of the preceding embodiments, wherein the Color Index hue of the colorant is orange.

Embodiment 19. The granule of any of the preceding embodiments, wherein the Color Index hue of the colorant is red.

Embodiment 20. The granule of any of the preceding embodiments, wherein the Color Index hue of the colorant is green.

Embodiment 21. The granule of any of the preceding embodiments, wherein the Color Index hue of the colorant is blue.

Embodiment 22. The granule of any of the preceding embodiments, wherein the Color Index hue of the colorant is violet.

Embodiment 23. The granule of any of the preceding embodiments, wherein the Color Index usage class of the colorant is selected from the group consisting of Acid, Basic, Direct, Food, Mordant, Natural, Reactive, Solvent, Vat, Sulphur, Disperse, and Pigment.

Embodiment 24. The granule of any of the preceding embodiments, wherein the Color Index usage class of the colorant is selected from the group consisting of Acid, Basic, Direct, Food, Mordant, Natural, Reactive, and Pigment.

Embodiment 25. The granule of any of the preceding embodiments, wherein the Color Index usage class of the colorant is selected from the group consisting of Acid, Basic, Food, and Natural.

Embodiment 26. The granule of any of the preceding embodiments, wherein the colorant is a naturally occurring colorant.

Embodiment 27. The granule of any of the preceding embodiments, wherein the colorant is a plant derived colorant.

Embodiment 28. The granule of any of the preceding embodiments, wherein the colorant is a dye.

Embodiment 29. The granule of any of the preceding embodiments, wherein the colorant is a pigment.

Embodiment 30. The granule of any of the preceding embodiments, which further comprises an outermost polymer coating surrounding the salt coating.

Embodiment 31. The granule of any of the preceding embodiments, which further comprises an outermost polymer coating surrounding the salt coating, comprising polyethylene glycol, methyl hydroxy-propyl cellulose, or polyvinyl alcohol.

Embodiment 32. The granule of any of the preceding embodiments, wherein the salt coating comprises at least 70% w/w of salt.

Embodiment 33. The granule of any of the preceding embodiments, wherein the salt coating comprises at least 80% w/w of salt.

Embodiment 34. The granule of any of the preceding embodiments, wherein the salt coating comprises at least 90% w/w of salt.

Embodiment 35. The granule of any of the preceding embodiments, wherein the salt coating comprises at least 95% w/w of salt.

Embodiment 36. The granule of any of the preceding embodiments, wherein the salt of the salt coating has a constant relative humidity at 20 °C of at least 70%.

Embodiment 37. The granule of any of the preceding embodiments, wherein the salt of the salt coating has a constant relative humidity at 20 °C of at least 80%.

Embodiment 38. The granule of any of the preceding embodiments, wherein the salt of the salt coating has a constant relative humidity at 20 °C of at least 85%.

Embodiment 39. The granule of any of the preceding embodiments, wherein the salt coating comprises sodium sulfate.

Embodiment 40. The granule of any of the preceding embodiments, wherein the salt coating makes up 1-50% w/w of the granule.

Embodiment 41. The granule of any of the preceding embodiments, wherein the salt coating makes up 2-40% w/w of the granule.

Embodiment 42. The granule of any of the preceding embodiments, wherein the salt coating makes up 5-40% w/w of the granule.

Embodiment 43. The granule of any of the preceding embodiments, wherein the thickness of the salt coating is 1-100 μm.

Embodiment 44. The granule of any of the preceding embodiments, wherein the thickness of the salt coating is 1-60 μm.

Embodiment 45. The granule of any of the preceding embodiments, wherein the thickness of the salt coating is 5-60 μm.

Embodiment 46. The granule of any of the preceding embodiments, wherein the volume based average particle size of the granule is 20-2000 μm.

Embodiment 47. The granule of any of the preceding embodiments, wherein the volume based average particle size of the granule is 50-1500 μm.

Embodiment 48. The granule of any of the preceding embodiments, wherein the volume based average particle size of the granule is 100-1500 μm.

Embodiment 49. The granule of any of the preceding embodiments, wherein the volume based average particle size of the granule is 250-1200 μm.

Embodiment 50. The granule of any of the preceding embodiments, which is water soluble or water dispersible.

Embodiment 51. The granule of any of the preceding embodiments, wherein the colorant has a sum of the numerical “a” and “b” values within the Hunter L,a,b color space of at least 20; preferably at least 30, at least 40, or at least 50.

Embodiment 52. The granule of any of the preceding embodiments, wherein the color of the granule has a sum of the numerical “a” and “b” values within the Hunter L,a,b color space of at least 20; preferably at least 30, at least 40, or at least 50.

Embodiment 53. A solid detergent composition, comprising a surfactant and a builder, and the colored granule of any of the preceding embodiments.

Embodiment 54. The solid detergent composition of the preceding embodiment, which further comprises a bleaching system component.

Embodiment 55. The solid detergent composition of the preceding embodiment, wherein the bleaching system component is a bleach activator, a bleach catalyst, or a percarbonate.

Embodiment 56. The solid detergent composition of the preceding embodiment, wherein the bleach catalyst is a Manganese bleach catalyst, such as MnTACN.

Embodiment 57. The solid detergent composition of embodiment 55 or 56, wherein the bleach activator is TAED or NOBS.

Embodiment 58. The solid detergent composition of embodiment 55, wherein the bleaching system component is sodium percarbonate.

Embodiment 59. The solid detergent composition of any of embodiments 53-58, which is an ADW detergent.

Embodiment 60. The solid detergent composition of any of embodiments 53-58, which is a laundry detergent.

Embodiment 61. The solid detergent composition of any of embodiments 53-60, which comprises the colored granule in an amount up to 10% w/w.

Embodiment 62. The solid detergent composition of the preceding embodiment, which comprises the colored granule in an amount up to 5% w/w.

### EXAMPLES

Chemicals were commercial products of at least reagent grade.

### Example 1

### Ex 1.1: Uncoated Green Granulate

5 kg white protease granulate (from Novozymes A/S) was fluidized in a coating fluid bed. The granulate was colored green by spraying the following mixture onto the granules:
2.50 g Food Yellow 13 (Puricolor Yellow FYE13 from BASF),
0.63 g Acid Blue 3 (or Food Blue 3),
4.00 g PEG4000 (polyethylene glycol Mw 4000), and
396 g water.

### Ex 1.2: Salt Coated Green Granulate

A green granulate was produced as in Ex. 1.1. A mixture of 500 g Na₂SO₄ and 1500 g water was sprayed onto the granules to prepare a salt coated green granulate. The color of the granulate differed only very slightly from the uncoated green granulate produced in Ex 1.1.

### Ex 1.3: Uncoated Red Granulate

4 kg white amylase granulate (from Novozymes A/S) was fluidized in a coating fluid bed. The granulate was colored red by spraying the following mixture onto the granules:
9.20 g Acid Red 18 (Food red 7, Puricolor Red ARE18 from BASF),
9.20 g MHPC (Culminal MHPC 5 from Ashland),
0.40 g sodium thiosulfate, and
950 g water.

### Ex 1.4: Salt Coated Red Granulate

A red granulate was produced as in Ex. 1.3. A mixture of 320 g Na₂SO₄ and 783 g water was sprayed onto the granules to prepare a salt coated red granulate. After the salt coating a film coating was applied by spraying a mixture of 44 g MHPC, 36 g PEG4000, and 836 g water onto the salt coated red granules. The color of the final granulate did not visually differ from the uncoated red granulate produced in Ex 1.3.

### Ex 1.5: Salt Coated Red Granulate

A red granulate was produced as in Ex. 1.3. A mixture of 480 g Na₂SO₄ and 1175 g water was sprayed onto the granules to prepare a salt coated red granulate. After the salt coating a film coating was applied by spraying a mixture of 44 g MHPC, 36 g PEG4000, and 836 g water onto the salt coated red granules. The color of the final granulate did not visually differ from the uncoated red granulate produced in Ex 1.3, and the salt coated red granulate produced in Ex 1.4.

### Color Stability of the Granulates

An automatic dish wash (ADW) powder detergent (ADW tablet base) was produced by mixing:
37.5% w/w Na₂SO₄
19.7% w/w Na-citrate dihydrate
16.8% w/w Na₂CO₃
4.9% w/w Sodium disilicate (Britesil H 265 HP)
4.9% w/w Copolymer of acrylic and sulphonic acids (Acusol 588G)
4.9% w/w Alcohol ethoxylate (Surfac 23-6.5) (liquid mixed into powder)
9.9% w/w Percarbonate granulate (13.5% w/w active oxygen)
0.4% w/w MnTACN granulate (6% w/w MnTACN)
1.0% w/w Glycerol (liquid mixed into powder)

Open glasses with 3 g of colored enzyme granulate (uncoated or salt coated) was mixed with 12 g of the ADW powder detergent. Accelerated color storage stability was tested by incubating the glasses at 37 °C and 70% relative humidity for 3 days (green granulate) or 12 days (red granulate), and subsequently compare the samples with reference samples stored at 5 °C.

After storage, the glasses were compared visually, and residual color was measured by dissolving the samples and measuring absorbance using a spectrophotometer. For the green granules an absorbance scan showed maximum at 380 nm (blue color) and 630 nm (yellow color), and for the red granules the maximum absorbance was found at 520 nm (red color):
The sample in each glass (15 g) was dissolved in 100 g deionized water (containing 0.1% Catazyme 25 L (catalase) from Novozymes to quench hydrogen peroxide),
Each sample was filtered through a 0.45 micron filter and diluted 1:1 with deionized water,
Absorbance was measured using the dissolved ADW powder as a reference, and
The residual absorbance (in percent) was calculated as absorbance for samples stored at 37 °C/70% RH divided by absorbance for samples stored at 5 °C.

TABLE 1
Colored granulates stored in ADW powder
at 37 °C and 70% relative humidity.

| | | | Residual | | |
|---|---|---|---|---|---|
| | | Residual | yellow | Residual | |
| Sample | | blue color | color | red color | Visual |
| granulate | Storage | (380 nm) | (630 nm) | (520 nm) | evaluation |
| Ex 1.1 | 3 days | 57.5% | 15.7% | — | Considerably |
| | | | | | faded |
| Ex 1.2 | 3 days | 70.9% | 33.3% | — | Slightly faded |
| Ex 1.3 | 12 days | — | — | 13.7% | Considerably |
| | | | | | faded |
| Ex 1.4 | 12 days | — | — | 32.7% | Slightly faded |
| Ex 1.5 | 12 days | — | — | 79.7% | Not faded |

As can be seen in Table 1, the coated granulates (Ex 1.2, Ex 1.4, Ex 1.5) were much more color stable than the uncoated granulates (Ex 1.1, Ex 1.3).

As described above, the salt coatings made little or no change to the color compared to the uncoated red and green granulates. The color coordinates of the red granules were measured using a Hunter ColorFlex, giving the Hunter coordinates L,a,b. The “L” value represents white/black, the “a” value represents red/green, and the “b” value represents yellow/blue. Thus, the red color of the red granules (Ex 1.3, Ex 1.4, Ex 1.5) can be evaluated by measuring the Hunter “a” coordinate.

TABLE 2

| Sample granulate (before storage) | Hunter “a” coordinate |
|---|---|
| Ex 1.3 | 50.6 |
| Ex 1.4 | 49.5 |
| Ex 1.5 | 49.1 |

The changes in the Hunter “a” values after applying the salt coatings were so small that they were not visible by visual inspection.

1. A colored granule, comprising
(a) a colored core comprising a colorant, and
(b) a salt coating surrounding the core, which makes up 1-50% w/w of the granule and comprises at least 60% w/w of a salt having a constant relative humidity at 20 °C of at least 60%, and which forms a continuous layer having few or no holes.

2. The colored granule of the preceding claim, which is water soluble/dispersible.

3. The colored granule of claim 1, wherein the colored core comprises a compound of interest in an amount of 0.05-50% w/w of the granule.

4. The colored granule of claim 1, wherein the colored core comprises the compound of interest in an amount of 0.1-30% w/w of the granule.

5. The colored granule of claim 1, wherein the colorant or the color of the granule has a sum of the numerical “a” and “b” values within the Hunter L,a,b color space of at least 20.

6. The colored granule of claim 1, wherein the colorant is listed in the Color Index, and the Color Index hue is selected from the group consisting of yellow, orange, red, green, blue, and violet.

7. The colored granule of claim 6, wherein the Color Index usage class is selected from the group consisting of Acid, Basic, Direct, Food, Mordant, Natural, Reactive, Solvent, Vat, Sulphur, Disperse, and Pigment.

8. The colored granule of claim 1, wherein the colorant is a naturally occurring colorant.

9. The colored granule of claim 1, wherein the colored core comprises the colorant as a coating at the surface of the core.

10. The colored granule of claim 1, wherein the salt coating makes up 2-40% w/w of the granule and comprises at least 80% w/w of a salt having a constant relative humidity at 20 °C of at least 80%.

11. The colored granule of claim 1, wherein the salt coating comprises sodium sulfate.

12. The colored granule of claim 1, wherein the salt has a solubility at least 0.1 grams in 100 g of water at 20 °C.

13. The colored granule of claim 1, which comprises less than 10% w/w surfactant.

14. The colored granule of claim 1, wherein the volume based average particle size is 100-1500 μm.

15. A solid detergent composition, comprising a surfactant and a builder, and the colored granule of claim 1 and a bleaching system component.

16. The solid detergent composition of claim 15, wherein the bleaching system component is a bleach activator, bleach catalyst, or percarbonate.

17. The colored granule of any of claim 1, wherein the compound of interest is an enzyme.

18. The colored granule of claim 1, wherein the colorant is a plant derived colorant.

19. The colored granule of claim 1, wherein the colored core comprises the compound of interest in an amount of 0.5-25% w/w of the granule.

20. The colored granule of claim 1, wherein the volume based average particle size is 250-1200 μm.
